(19) United States
(12) Patent Application Publication
(10) Pub. No.: US 2009/0047832 A1
(43) Pub. Date: Feb. 19, 2009

(54) Low profile electrical connector

(75) Inventors: Hui Zhu, ShenZhen (CN); Wei Yuan, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/228,974

(22) Filed: Aug. 18, 2008

(30) Foreign Application Priority Data
Aug. 17, 2007 (CN) 200720042938.5

(51) Int. Cl. H01R 13/646

(52) U.S. Cl. 439/625

(57) ABSTRACT

An electrical connector comprises an insulative housing and a plurality of terminals received in the insulative housing. The insulative housing has a mating portion, and the mating portion defines a plurality of receiving slots, an inserting slot communicating with the plurality of receiving slots and a pair of guiding posts respectively and symmetrically disposed at two sides of the inserting slot. The pair of guiding posts locating within the spectrum of the height of the inserting slot.

### BACKGROUND OF THE INVENTION

1. Field of the Invention

The present invention relates to an electrical connector, and particularly to an electrical connector adapted for mounting on a print circuit board.

2. Description of the Related Art

With the rapid development of the technology of wireless communication and advanced technology of electrics, electrical connectors are designed to establish an electrical connection between a storage device and a print circuit board for high-speed signal transmission.

Usually, these electrical connectors are mounted on a print circuit board or terminated with cable. Please referring to US 2003/0096517 A1, Ho discloses an electrical connector 1, comprising an insulative housing 11 and a plurality of terminals 12 received in the insulative housing 11. The insulative housing 11 is elongated and comprises a plurality of receiving slots 117 for receiving the terminals 12 and a mating port 115 engaging with complementary connector. The insulative housing 11 defines a front face 1101, a rear face 1102 opposite to the front face 1101 and a pair of side walls 1104, 1105 adjoining the front face 1101 and the rear face 1102. The side walls 1104, 1105 respectively defines a guiding post at the middle portion thereof. The height of each guiding post is about equal to that of the side wall. Accordingly, the complementary connector defines a guiding slot cooperating with the guiding post. However, electrical connector accommodated in this electronic device should be with compact structure to comply with the miniature trend. Due to the position and the height of the pair guiding posts, the height of the guiding slot of the complementary should be increased to make sure the tongue plate and guiding slot are respectively corresponding to the mating port and the guiding posts of the electrical connector 1. Therefore, this design is adverse to reduce the total height of the electrical connector and its complementary connector, and also increase the total cost.

Hence, an improved electrical connector is desired to overcome the disadvantages of the prior art.

### BRIEF SUMMARY OF THE INVENTION

Therefore, a main object of the present invention is to provide an electrical connector with low profile.

To fulfill the above-mentioned object, an electrical connector comprises an insulative housing and a plurality of terminals received in the insulative housing. The insulative housing has a mating portion, and the mating portion defines a plurality of receiving slots, an inserting slot communicating with the plurality of receiving slots and a pair of guiding posts respectively and symmetrically disposed at two sides of the inserting slot. The pair of guiding posts locating within the spectrum of the height of the inserting slot.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is an assembled, perspective view of an electrical connector according to the present invention;

FIG. 2 is an exploded, perspective view of an electrical connector according to the present invention;

FIG. 3 is a view similar to FIG. 2, but viewed from another aspect; and

FIG. 4 is a front elevational view of FIG. 1.

### DETAILED DESCRIPTION OF THE PREFERRED EMBODIMENT

Reference will now be made in detail to the preferred embodiment of the present invention.

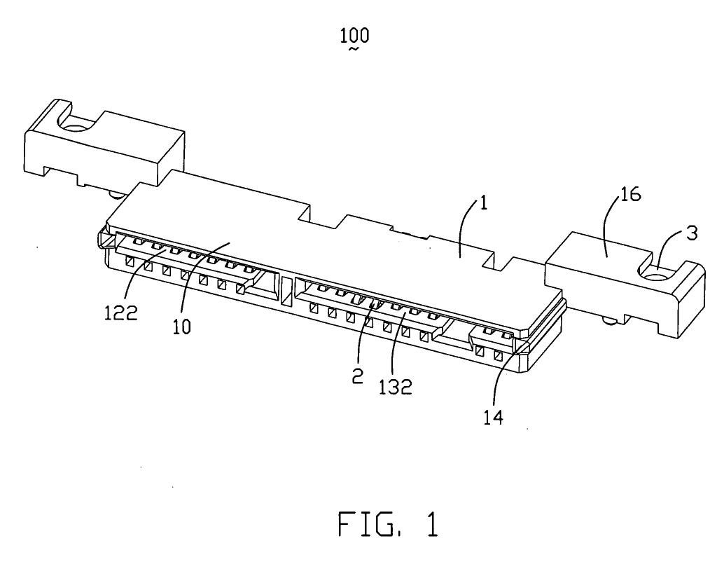

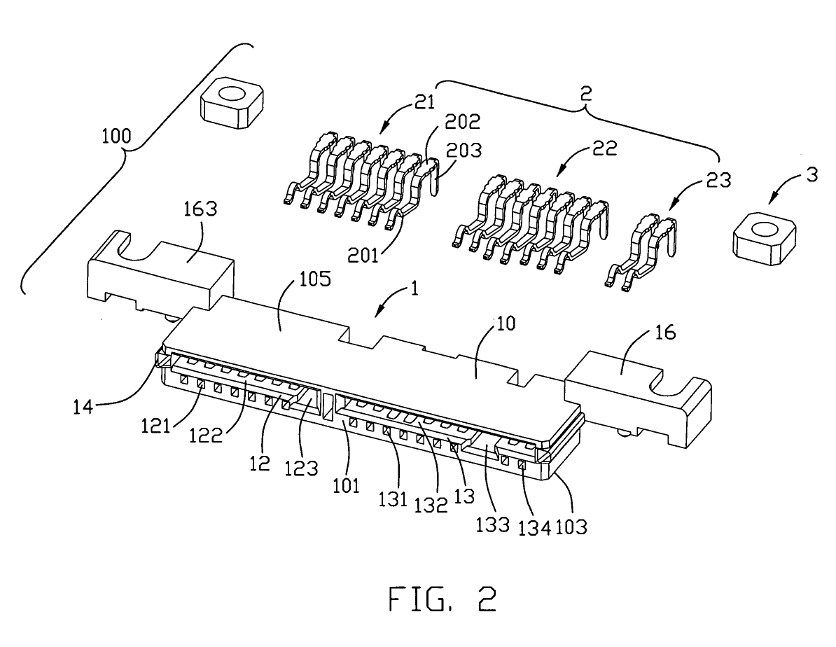

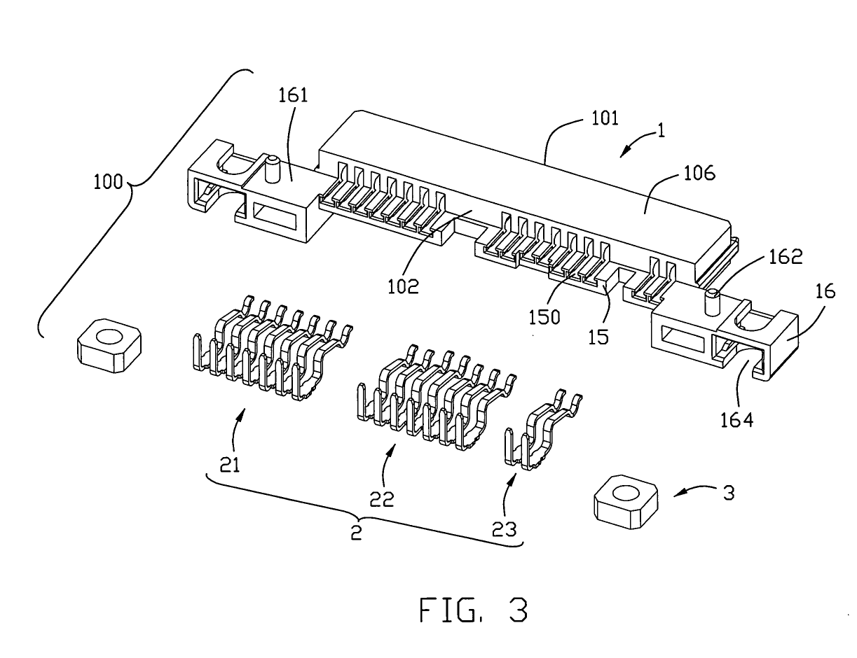

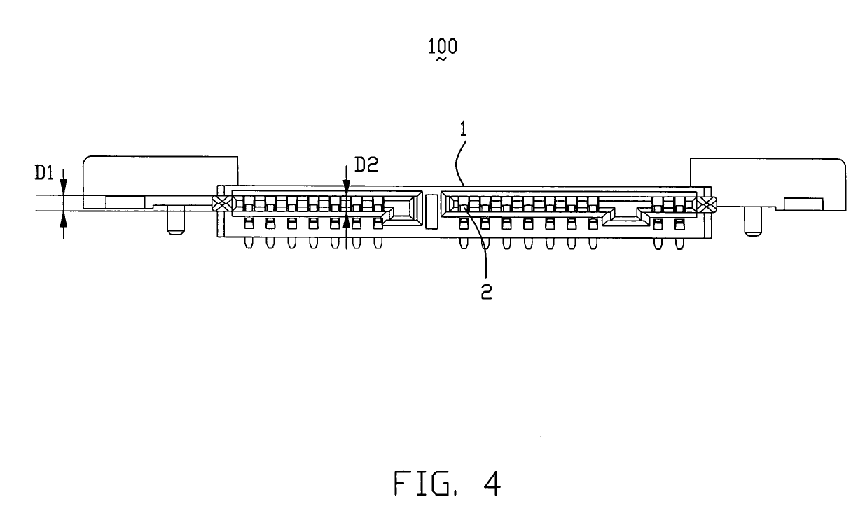

Referring to FIGS. 1-4, an electrical connector 100 according to the present invention is adapted for electrically connecting a complementary connector (not shown) and a print circuit board (not shown). The electrical connector 100 comprises an insulative housing 1, a plurality of terminals 2 received in the insulative housing 1 and a pair of retaining members 4 assembled with the insulative housing 1.

The insulative housing 1 comprises an elongated mating portion 10 and a pair of mounting platforms 16 located at two sides of the mating portion 10. The mating portion 10 defines a mating face 101, rear face 102 opposite to the mating face 101, a pair of side walls 103, an upper wall 105 and a bottom wall 106 opposite to the upper wall 105. In the preferred embodiment, the rear face 102 is as the rear direction, and the mating face 101 is as the front direction.

To meet the needs of the signal transmission, the mating portion 10 defines a first receiving port 12 and a second receiving port 13 adjacent to the first receiving port 12 at the mating face 101 of the mating face 101. The first receiving port 12 defines a plurality of receiving slots 121 communicating with the rear face 102 and the mating face 101, a first inserting slot 122 communicating with the first receiving slots 121 and a first positioning groove 123 communicating with and perpendicular to the first inserting slot 122. The first inserting slot 122 and the first positioning groove 123 together define a L-shaped receiving channel (not labeled). The second receiving port 13 defines a plurality of second receiving slots 131 and third receiving slots 134 respectively communicating with the rear face 102 and the mating face 103, a second inserting slot 132 communicating with the second receiving slots 131 and the third receiving slots 134 and a second positioning groove 133 communicating with the second inserting slot 132. The second positioning groove 133 is disposed between the second receiving slots 131 and the third receiving slots 134, and together forms a T-shaped receiving channel (not labeled) with the second inserting slot 132. The mating portion 10 has a pair of guiding posts 14 respectively disposed at two sides thereof and a plate 15 extending rearwardly from the upper wall 105 with a plurality of retaining slots 150 corresponding to the first, second and third receiving slots (121, 131, 134). The pair of guiding posts 14 are symmetrically located at two sides of the first inserting slot 122 and the second inserting slot 132 with the height (D1) not larger than the height (D2) of the first inserting slot 122 and the second inserting slot 132. It means that the guiding posts 14 are located within the boundary of the D2. In the preferred embodiment, the height D1 of the guiding posts are about equal to the height D2.

Each mounting platform 16 defines a mounting face 161 adapting for a print circuit board (not labeled), a upper face 163 opposite to the mounting face 161, a retaining post 162 extending downwardly from the mounting face 161 and a receiving chamber 164 accommodating a retaining member 3. The mounting face 161 is coplanar with the under face of the plate 15 and higher than that of the bottom wall 106 of the mating portion 10. The upper face 163 is above the upper wall 105 of the mating portion 10. This type design is facilitate decreasing the total height of the connector.

The terminals 2 comprise a plurality of first terminals 21 received in the first receiving port 12 and a plurality of second and third terminals 22, 23 received in the second receiving port 13. The first, second and third terminals 21, 22, 23 are of substantial same shape, and each comprises a contacting portion 201, a retaining portion 202 extending rearwardly and upwardly from the contacting portion 201 and a tail portion 203 extending downwardly from the retaining portion 202. The first terminals 21 are assembled into the first receiving slots 121 of the first receiving port 12. The second and third terminals 22, 23 are respectively assembled into the second receiving slots 131 and the third receiving slots 234 of the second receiving port 13 with the contacting portions 201 of the terminals 2 respectively received in the receiving slots (121, 131, 134) and exposed within the first inserting slot 122 and the second inserting slot 132, the retaining portions 202 retained in the retaining slots 150 and the tail portions 203 electrically connecting with a print circuit board.

The electrical connector 1 can maintain the total height of a complementary connector with the pair guiding posts 14 disposed within the spectrum of the height (D2) of the inserting slot (122, 132). Accordingly, the total cost is decreased.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulative housing having a mating portion defining a plurality of receiving slots, an inserting slot communicating with the plurality of receiving slots and a pair of guiding posts respectively and symmetrically disposed at two sides of the inserting slot, and said pair of guiding posts locating within the spectrum of the height of the inserting slot;
a plurality of terminals received in said receiving slots of the insulative housing.

2. The electrical connector as described in claim 1, wherein the mating portion defines a first receiving port and a second receiving port adjacent to the first receiving port.

3. The electrical connector as claimed in claim 2, wherein the inserting slot comprises a first inserting slot disposed in the first receiving port and a second inserting slot disposed in the second receiving port, said receiving slots comprise first receiving slots disposed in the first receiving port and second receiving slots disposed in the second receiving port, said first receiving slots and the second receiving slots communicating with the first inserting slot and the second inserting slot, respectively.

4. The electrical connector as claimed in claim 3, wherein the receiving slots comprise third receiving slots disposed in the second receiving port, the first receiving port defines a first positioning groove communicating with and perpendicular to the first inserting slot, the second receiving port defines a second positioning groove communicating with and perpendicular to the second inserting slot, the second positioning groove separates the second receiving slots and the third receiving slots.

5. The electrical connector as claimed in claim 4, wherein the first inserting slot and the first positioning groove together define a L-shaped receiving channel, the second inserting slot and the second positioning groove together define a T-shaped receiving channel.

6. The electrical connector as described in claim 1, wherein the mating portion is elongated, and defines a mating face, a rear face opposite to the mating face, a upper wall, a bottom wall opposite to the upper wall and a pair of side walls connecting with the upper wall and the bottom wall, the mating portion comprises a plate extending rearwardly from the upper wall and with a plurality of retaining slots on the lower surface thereof and corresponding to the plurality of receiving slots.

7. The electrical connector as described in claim 6, wherein the insulative housing comprises a pair of mounting platforms at two rear sides thereof, the mounting platform has a mounting face coplanar with the lower surface of the plate.

8. The electrical connector as claimed in claim 7, wherein the mounting face of the mounting platform is above the bottom wall of the mating portion.

9. An electrical connector, comprising:
an insulative housing having a mating portion and a pair mounting platforms located at two sides of the mating portion, said mating portion defining a plurality of receiving slots, an inserting slot communicating with the plurality of receiving slots and a pair of guiding posts respectively and symmetrically disposed at two sides of the inserting slot, and said pair of guiding posts locating within the spectrum of the height of the inserting slot, said each mounting platform;
a plurality of terminals received in said receiving slots of the insulative housing.

10. The electrical connector as claimed in claim 9, wherein the height of the guiding post is smaller than that of the inserting slot.

11. An electrical connector assembly comprising:
a printed circuit board defining an upward mounting surface;
an electrical connector including an insulative housing defining a forwardly extending mating portion with a pair of mounting towers by two ends thereof under a condition that a bottom surface of the mating portion is lower than a bottom face of each of said mounting towers; wherein
a pair of guiding posts unitarily formed at two opposite ends of the mating portion and essentially located at a mid-level of the mating portion, under a condition that a bottom face of each of said guiding posts is essentially coplanar with the bottom face of the mounting tower.
